(19) United States
(12) Patent Application Publication
(10) Pub. No.: US 2010/0152380 A1
(43) Pub. Date: Jun. 17, 2010

(54) PROCESS FOR PREPARING AN AQUEOUS POLYMER DISPERSION

(75) Inventor: Rajan Venkatesh, Mannheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/295,629

(22) PCT Filed: Mar. 28, 2007
(86) PCT No.: PCT/EP07/52953

§ 371 Date: Oct. 1, 2008

(30) Foreign Application Priority Data
Apr. 6, 2006 (EP) 06112325.3

(51) Int. Cl. C08F 2/22

(52) U.S. Cl. 524/833

(57) ABSTRACT

Process for preparing an aqueous polymer dispersion using alkenes of 5 to 12 carbon atoms.

The present invention provides a process for preparing an aqueous polymer dispersion by free-radically initiated aqueous emulsion polymerization of ethylenically unsaturated monomers in the presence of at least one dispersant and at least one free-radical initiator, wherein
1 to 50% by weight of an alkene of 5 to 12 carbon atoms [monomer A] and
50 to 99% by weight of an ester based on an α,β-monoethylenically unsaturated monocarboxylic or dicarboxylic acid of 3 to 6 carbon atoms and an alkanol of 1 to 12 carbon atoms [monomer B], and also, if appropriate,
0 to 10% by weight of an α,β-monoethylenically unsaturated monocarboxylic or dicarboxylic acid of 3 to 6 carbon atoms and/or amide thereof [monomer C] and
0 to 30% by weight of an α,β-ethylenically unsaturated compound [monomer D] different than monomers A to C
   are used for the emulsion polymerization, monomers A to D adding to 100% by weight, wherein at least 50% by weight of the total amount of monomers A and optionally up to 10% by weight each of the total amounts of monomers B to D are included in the initial charge to the polymerization vessel before the polymerization reaction is initiated, and any remainder of monomers A, and the total amounts or, if appropriate, the remainders of monomers B to D are supplied to the polymerization vessel under polymerization conditions.

Processes for preparing polymers based on alkenes and other copolymerizable ethylenically unsaturated compounds are well known to the skilled worker. The copolymerization takes place essentially in the form of a solution polymerization (see, for example, A. Sen et al., Journal American Chemical Society, 2001, 123, pages 12738-39; B. Klumperman et al., Macromolecules, 2004, 37, pages 4406-16; A. Sen et al., Journal of Polymer Science, Part A: Polymer Chemistry, 2004, 42(24), pages 6175-92; WO 03/042254, WO 03/091297 or EP-A 1384729) or in the form of an aqueous emulsion polymerization, this taking place in particular on the basis of the lowest alkene, ethene (see, for example, U.S. Pat. No. 4,921,898, U.S. Pat. No. 5,070,134, U.S. Pat. No. 5,110,856, U.S. Pat. No. 5,629,370, EP-A 295727, EP-A 757065, EP-A 1114833 or DE-A 19620817).

Prior art relating to free-radically initiated aqueous emulsion polymerization using higher alkenes is as follows: DE-A 1720277 discloses a process for preparing film-forming aqueous polymer dispersions using vinyl esters and 1-octene. The weight ratio of vinyl ester to 1-octene can be from 99:1 to 70:30. Optionally the vinyl esters can be used to a minor extent in a mixture with other copolymerizable ethylenically unsaturated compounds for the emulsion polymerization.

S. M. Samoilov in J. Macromol. Sci. Chem., 1983, A19(1), pages 107-22 describes the free-radically initiated aqueous emulsion polymerization of propene with different ethylenically unsaturated compounds. The outcome observed there was that the copolymerization of propene with ethylenically unsaturated compounds having strongly electron-withdrawing groups, such as chlorotrifluoroethylene, trifluoroacrylonitrile, maleic anhydride or methyl trifluoroacrylate, gave polymers having a markedly higher propene fraction, or copolymers having higher molecular weights, than when using the typical ethylenically unsaturated compounds of free-radically initiated aqueous emulsion polymerization, viz. vinyl acetate, vinyl chloride, methyl acrylate, and butyl acrylate. The reasons given for this behavior include in particular the hydrogen radical transfer reactions that are typical of the higher alkenes.

In the German patent application filed by the applicant under application number DE 10 2005 035 692.3, the preparation of aqueous polymer dispersions based on alkenes having 5 to 12 carbon atoms is disclosed. In that case the alkenes having 5 to 12 carbon atoms are metered into the polymerization mixture under polymerization conditions.

It was an object of the present invention to improve the preparation process for aqueous polymer dispersions that was disclosed in German patent application DE 10 2005 035 692.3 in terms of the monomer conversions that could be achieved.

Surprisingly this object has been achieved by means of the process defined at the outset.

The implementation of free-radically initiated emulsion polymerizations of ethylenically unsaturated monomers in an aqueous medium has been described on numerous occasions before now and is therefore sufficiently well known to the skilled worker [cf., in this regard, Emulsion Polymerization in Encyclopedia of Polymer Science and Engineering, Vol. 8, pages 659 ff. (1987); D. C. Blackley, in High Polymer Latices, Vol. 1, pages 35 ff. (1966); H. Warson, The Applications of Synthetic Resin Emulsions, Chapter 5, pages 246 ff. (1972); D. Diederich, Chemie in unserer Zeit 24, pages 135-42 (1990); Emulsion Polymerisation, Interscience Publishers, New York (1965); DE-A 40 03 422, and Dispersionen synthetischer Hochpolymerer, F. Hölscher, Springer-Verlag, Berlin (1969)]. The free-radically initiated aqueous emulsion polymerization reactions typically take place such that the ethylenically unsaturated monomers are distributed dispersely in the aqueous medium in the form of monomer droplets, using dispersants, and are polymerized by means of a free-radical polymerization initiator. The present process differs from this procedure only in the use of a specific monomer composition and the specific manner of monomer supply.

In the present process of the invention, water, frequently of drinking grade, but with particular preference deionized water, is used, the total amount thereof being calculated such that it amounts to ≧30% and ≦90% by weight and advantageously ≧40% and ≦75% by weight, based in each case on the aqueous polymer dispersion obtainable through the process of the invention.

In accordance with the invention it is possible to include a portion or the entirety of water in the initial charge to the polymerization vessel and to meter in any remainder of water after the polymerization reaction has been initiated. In this context it is possible to meter any remainder of water into the polymerization vessel discontinuously, in one or more portions, or continuously, with flow rates which are constant or vary. With particular advantage the water feed takes place continuously with constant flow rates, especially as part of an aqueous monomer emulsion and/or of an aqueous solution of the free-radical initiator.

Useful monomers A include all linear or cyclic alkenes of 5 to 12 carbon atoms, preferably 5 to 10 carbon atoms, and more preferably 6 to 8 carbon atoms which can be free-radically copolymerized and which other than carbon and hydrogen contain no further elements. This includes, for example, the linear alkenes 2-methylbut-1-ene, 3-methylbut-1-ene, 3,3-dimethyl-2-isopropylbut-1-ene, 2-methylbut-2-ene, 3-methylbut-2-ene, pent-1-ene, 2-methylpent-1-ene, 3-methylpent-1-ene, 4-methylpent-1-ene, pent-2-ene, 2-methylpent-2-ene, 3-methylpent-2-ene, 4-methylpent-2-ene, 2-ethylpent-1-ene, 3-ethylpent-1-ene, 4-ethylpent-1-ene, 2-ethylpent-2-ene, 3-ethylpent-2-ene, 4-ethylpent-2-ene, 2,4,4-trimethylpent-1-ene, 2,4,4-trimethylpent-2-ene, 3-ethyl-2-methylpent-1-ene, 3,4,4-trimethylpent-2-ene, 2-methyl-3-ethylpent-2-ene, hex-1-ene, 2-methylhex-1-ene, 3-methylhex-1-ene, 4-methylhex-1-ene, 5-methylhex-1-ene, hex-2-ene, 2-methylhex-2-ene, 3-methylhex-2-ene, 4-methylhex-2-ene, 5-methylhex-2-ene, hex-3-ene, 2-methylhex-3-ene, 3-methylhex-3-ene, 4-methylhex-3-ene, 5-methylhex-3-ene, 2,2-dimethylhex-3-ene, 2,3-dimethylhex-2-ene, 2,5-dimethylhex-3-ene, 2,5-dimethylhex-2-ene, 3,4-dimethylhex-1-ene, 3,4-dimethylhex-3-ene, 5,5-dimethylhex-2-ene, 2,4-dimethylhex-1-ene, hept-1-ene, 2-methylhept-1-ene, 3-methylhept-1-ene, 4-methylhept-1-ene, 5-methylhept-1-ene, 6-methylhept-1-ene, hept-2-ene, 2-methylhept-2-ene, 3-methylhept-2-ene, 4-methylhept-2-ene, 5-methylhept-2-ene, 6-methylhept-2-ene, hept-3-ene, 2-methylhept-3-ene, 3-methylhept-3-ene, 4-methylhept-3-ene, 5-methylhept-3-ene, 6-methylhept-3-ene, 6,6-dimethylhept-1-ene, 3,3-dimethylhept-1-ene, 3,6-dimethylhept-1-ene, 2,6-dimethylhept-2-ene, 2,3-dimethylhept-2-ene, 3,5-dimethylhept-2-ene, 4,5-dimethylhept-2-ene, 4,6-dimethylhept-2-ene, 4-ethylhept-3-ene, 2,6-dimethylhept-3-ene, 4,6-dimethylhept-3-ene, 2,5-dimethylhept-4-ene, oct-1-ene, 2-methyloct-1-ene, 3-methyloct-1-ene, 4-methyloct-1-ene, 5-methyloct-1-ene, 6-methyloct-1-ene, 7-methyloct-1-ene, oct-2-ene, 2-methyloct-2-ene, 3-methyloct-2-ene, 4-methyloct-2-ene, 5-methyloct-2-ene, 6-methyloct-2-ene, 7-methyloct-2-ene, oct-3-ene, 2-methyloct-3-ene, 3-methyloct-3-ene, 4-methyloct-3-ene, 5-methyloct-3-ene, 6-methyloct-3-ene, 7-methyloct-3-ene, oct-4-ene, 2-methyloct-4-ene, 3-methyloct-4-ene, 4-methyloct-4-ene, 5-methyloct-4-ene, 6-methyloct-4-ene, 7-methyloct-4-ene, 7,7-dimethyloct-1-ene, 3,3-dimethyloct-1-ene, 4,7-dimethyloct-1-ene, 2,7-dimethyloct-2-ene, 2,3-dimethyloct-2-ene, 3,6-dimethyloct-2-ene, 4,5-dimethyloct-2-ene, 4,6-dimethyloct-2-ene, 4,7-dimethyloct-2-ene, 4-ethyloct-3-ene, 2,7-dimethyloct-3-ene, 4,7-dimethyloct-3-ene, 2,5-dimethyloct-4-ene, non-1-ene, 2-methylnon-1-ene, 3-methylnon-1-ene, 4-methylnon-1-ene, 5-methylnon-1-ene, 6-methylnon-1-ene, 7-methylnon-1-ene, 8-methylnon-1-ene, non-2-ene, 2-methylnon-2-ene, 3-methylnon-2-ene, 4-methylnon-2-ene, 5-methylnon-2-ene, 6-methylnon-2-ene, 7-methylnon-2-ene, 8-methylnon-2-ene, non-3-ene, 2-methylnon-3-ene, 3-methylnon-3-ene, 4-methylnon-3-ene, 5-methylnon-3-ene, 6-methylnon-3-ene, 7-methylnon-3-ene, 8-methylnon-3-ene, non-4-ene, 2-methylnon-4-ene, 3-methylnon-4-ene, 4-methylnon-4-ene, 5-methylnon-4-ene, 6-methylnon-4-ene, 7-methylnon-4-ene, 8-methylnon-4-ene, 4,8-dimethylnon-1-ene, 4,8-dimethylnon-4-ene, 2,8-dimethylnon-4-ene, dec-1-ene, 2-methyldec-1-ene, 3-methyldec-1-ene, 4-methyldec-1-ene, 5-methyldec-1-ene, 6-methyldec-1-ene, 7-methyldec-1-ene, 8-methyldec-1-ene, 9-methyldec-1-ene, dec-2-ene, 2-methyldec-2-ene, 3-methyldec-2-ene, 4-methyldec-2-ene, 5-methyldec-2-ene, 6-methyldec-2-ene, 7-methyldec-2-ene, 8-methyldec-2-ene, 9-methyldec-2-ene, dec-3-ene, 2-methyldec-3-ene, 3-methyldec-3-ene, 4-methyldec-3-ene, 5-methyldec-3-ene, 6-methyldec-3-ene, 7-methyldec-3-ene, 8-methyldec-3-ene, 9-methyldec-3-ene, dec-4-ene, 2-methyldec-4-ene, 3-methyldec-4-ene, 4-methyldec-4-ene, 5-methyldec-4-ene, 6-methyldec-4-ene, 7-methyldec-4-ene, 8-methyldec-4-ene, 9-methyldec-4-ene, dec-5-ene, 2-methyldec-5-ene, 3-methyldec-5-ene, 4-methyldec-5-ene, 5-methyldec-5-ene, 6-methyldec-5-ene, 7-methyldec-5-ene, 8-methyldec-5-ene, 9-methyldec-5-ene, 2,4-dimethyldec-1-ene, 2,4-dimethyldec-2-ene, 4,8-dimethyldec-1-ene, undec-1-ene, 2-methylundec-1-ene, 3-methylundec-1-ene, 4-methylundec-1-ene, 5-methylundec-1-ene, 6-methylundec-1-ene, 7-methylundec-1-ene, 8-methylundec-1-ene, 9-methylundec-1-ene, 10-methylundec-1-ene, undec-2-ene, 2-methylundec-2-ene, 3-methylundec-2-ene, 4-methylundec-2-ene, 5-methylundec-2-ene, 6-methylundec-2-ene, 7-methylundec-2-ene, 8-methylundec-2-ene, 9-methylundec-2-ene, 10-methylundec-2-ene, undec-3-ene, 2-methylundec-3-ene, 3-methylundec-3-ene, 4-methylundec-3-ene, 5-methylundec-3-ene, 6-methylundec-3-ene, 7-methylundec-3-ene, 8-methylundec-3-ene, 9-methylundec-3-ene, 10-methylundec-3-ene, undec-4-ene, 2-methylundec-4-ene, 3-methylundec-4-ene, 4-methylundec-4-ene, 5-methylundec-4-ene, 6-methylundec-4-ene, 7-methylundec-4-ene, 8-methylundec-4-ene, 9-methylundec-4-ene, 10-methylundec-4-ene, undec-5-ene, 2-methylundec-5-ene, 3-methylundec-5-ene, 4-methylundec-5-ene, 5-methylundec-5-ene, 6-methylundec-5-ene, 7-methylundec-5-ene, 8-methylundec-5-ene, 9-methylundec-5-ene, 10-methylundec-5-ene, dodec-1-ene, dodec-2-ene, dodec-3-ene, dodec-4-ene, dodec-5-ene or dodec-6-ene, and the cyclic alkenes cyclopentene, 2-methylcyclopent-1-ene, 3-methylcyclopent-1-ene, 4-methylcyclopent-1-ene, 3-butylcyclopent-1-ene, vinylcyclopentane, cyclohexene, 2-methylcyclohex-1-ene, 3-methylcyclohex-1-ene, 4-methylcyclohex-1-ene, 1,4-dimethylcyclohex-1-ene, 3,3,5-trimethylcyclohex-1-ene, 4-cyclopentylcyclohex-1-ene, vinylcyclohexane, cycloheptene, 1,2-dimethylcyclohept-1-ene, cyclooctene, 2-methylcyclooct-1-ene, 3-methylcyclooct-1-ene, 4-methylcyclooct-1-ene, 5-methylcyclooct-1-ene, cyclononene, cyclodecene, cycloundecene, cyclododecene, bicyclo[2.2.1]hept-2-ene, 5-ethylbicyclo[2.2.1]hept-2-ene, 2-methylbicyclo[2.2.2]oct-2-ene, bicyclo[3.3.1]non-2-ene or bicyclo[3.2.2]non-6-ene.

Preference is given to using the 1-alkenes, examples being pent-1-ene, hex-1-ene, hept-1-ene, oct-1-ene, non-1-ene, dec-1-ene, undec-1-ene, dodec-1-ene, 2,4,4-trimethylpent-1-ene, 2,4-dimethylhex-1-ene, 6,6-dimethylhept-1-ene or 2-methyloct-1-ene. As monomer A it is advantageous to use an alkene of 6 to 8 carbon atoms, preferably a 1-alkene of 6 to 8 carbon atoms. Particular preference is given to using hex-1-ene, hept-1-ene or oct-1-ene. It will be appreciated that mixtures of the aforementioned monomers A as well can be used.

Finding use as monomers B are esters based on an α,β-monoethylenically unsaturated monocarboxylic or dicarboxylic acid of 3 to 6 carbon atoms, in particular of 3 or 4 carbon atoms, such as, in particular, acrylic acid, methacrylic acid, maleic acid, fumaric acid, and itaconic acid, and an alkanol of 1 to 12 carbon atoms, preferably an alkanol of 1 to 8 carbon atoms, and in particular an alkanol of 1 to 4 carbon atoms, such as, in particular, methanol, ethanol, n-propanol, isopropanol, n-butanol, 2-methylpropan-1-ol, tert-butanol, n-pentanol, 3-methylbutan-1-ol, n-hexanol, 4-methylpentan-1-ol, n-heptanol, 5-methylhexan-1-ol, n-octanol, 6-methylheptan-1-ol, n-nonanol, 7-methyloctan-1-ol, n-decanol, 8-methylnonan-1-ol, n-dodecanol, 9-methyldecan-1-ol or 2-ethylhexan-1-ol. Preference is given to using methyl, ethyl, n-butyl, isobutyl, pentyl, hexyl, heptyl, octyl, nonyl, decyl, 2-ethylhexyl, or dodecyl acrylate and methacrylate, dimethyl or -di-n-butyl fumarate and maleate. It will be appreciated that mixtures of the aforementioned esters as well can be used.

Monomers C used are, optionally, α,β-monoethylenically unsaturated monocarboxylic or dicarboxylic acids of 3 to 6 carbon atoms and/or their amides, such as, in particular, acrylic acid, methacrylic acid, maleic acid, fumaric acid or itaconic acid and acrylamide or methacrylamide. It will be appreciated that mixtures of the aforementioned monomers C as well can be used.

Examples of monomers finding use as monomers D, which are different than monomers A to C, include α,β-ethylenically unsaturated compounds, such as vinylaromatic monomers, such as styrene, α-methylstyrene, o-chlorostyrene or vinyltoluenes, vinyl halides, such as vinyl chloride or vinylidene chloride, esters of vinyl alcohol and monocarboxylic acids of 1 to 18 carbon atoms, such as vinyl acetate, vinyl propionate, vinyl n-butyrate, vinyl laurate, and vinyl stearate, nitriles of α,β-monoethylenically or diethylenically unsaturated carboxylic acids, such as acrylonitrile, methacrylonitrile, fumaronitrile, maleonitrile, and conjugated dienes of 4 to 8 carbon atoms, such as 1,3-butadiene and isoprene, and additionally vinylsulfonic acid, 2-acrylamido-2-methylpropanesulfonic acid, styrenesulfonic acid, and their water-soluble salts, and also N-vinylpyrrolidone, 2-vinylpyridine, 4-vinylpyridine, 2-vinylimidazole, 2-(N,N-dimethylamino)ethyl acrylate, 2-(N,N-dimethylamino)ethyl methacrylate, 2-(N,N-diethylamino)ethyl acrylate, 2-(N,N-diethylamino)ethyl methacrylate, 2-(N-tert-butylamino)ethyl methacrylate, N-(3-N′,N′-dimethylaminopropyl)methacrylamide or 2-(1-imidazolin-2-onyl)ethyl methacrylate. Other monomers D have at least one epoxy, hydroxyl, N-methylol or carbonyl group, or at least two nonconjugated ethylenically unsaturated double bonds. Examples thereof are monomers containing two vinyl radicals, monomers containing two vinylidene radicals, and monomers containing two alkenyl radicals. Particular advantage in this context is possessed by the diesters of dihydric alcohols with α,β-monoethylenically unsaturated monocarboxylic acids, among which acrylic acid and methacrylic acid are preferred. Examples of monomers of this kind containing two nonconjugated ethylenically unsaturated double bonds are alkylene glycol diacrylates and dimethacrylates, such as ethylene glycol diacrylate, 1,2-propylene glycol diacrylate, 1,3-propylene glycol diacrylate, 1,3-butylene glycol diacrylate, 1,4-butylene glycol diacrylates, and ethylene glycol dimethacrylate, 1,2-propylene glycol dimethacrylate, 1,3-propylene glycol dimethacrylate, 1,3-butylene glycol dimethacrylate, and 1,4-butylene glycol dimethacrylate, and also divinylbenzene, vinyl methacrylate, vinyl acrylate, allyl methacrylate, allyl acrylate, diallyl maleate, diallyl fumarate, methylenebisacrylamide, cyclopentadienyl acrylate, triallyl cyanurate or triallyl isocyanurate. Of particular importance in this context are also the methacrylic and acrylic acid C₁-C₈ hydroxyalkyl esters such as n-hydroxyethyl, n-hydroxypropyl or n-hydroxybutyl acrylate and methacrylate, and also compounds such as glycidyl acrylate or methacrylate, diacetoneacrylamide, and acetylacetoxyethyl acrylate or methacrylate. It will be appreciated that mixtures of monomers D as well can be used.

It is, however, preferred to carry out the free-radically initiated aqueous emulsion polymerization using

1 to 49.99% by weight of monomers A,
50 to 98.99% by weight of monomers B, and
0.01 to 10% by weight of monomers C.

Monomers A used are, in particular, pent-1-ene, hex-1-ene, hept-1-ene, oct-1-ene, 3-methylhex-1-ene, 3-methylhept-1-ene and/or 3-methyloct-1-ene, monomers B used are, in particular, n-butyl acrylate, methyl acrylate, 2-ethylhexyl acrylate, methyl methacrylate and/or tert-butyl acrylate, and monomers C used are, in particular, acrylic acid, methacrylic acid and/or itaconic acid.

With particular preference the free-radically initiated aqueous emulsion polymerization is carried out using
5 to 40% by weight of pent-1-ene, hex-1-ene and/or oct-1-ene [monomers A],
56 to 94.9% by weight of n-butyl acrylate, methyl acrylate, 2-ethylhexyl acrylate, methyl methacrylate and/or tert-butyl acrylate [monomers B], and
0.1 to 4% by weight of acrylic acid and/or methacrylic acid [monomers C].

It is essential to the process that at least 50% by weight of the total amount of monomers A be included in the initial charge to the polymerization vessel before the polymerization reaction is initiated, and that any remainder of monomers A and the total amounts or, if appropriate, remainders of monomers B to D be supplied to the polymerization vessel under polymerization conditions.

Advantageously ≧60% or 70% by weight and with particular advantage ≧80% or ≧90% by weight of the total amount, or even the total amount, of monomers A are included in the initial charge to the polymerization vessel before the polymerization reaction is initiated. The metered addition of any remainder of monomers A, i.e., ≦50%, ≦40%, ≦30%, ≦20% or ≦10% by weight of the total amount of monomers A, after the free-radical polymerization reaction has been initiated, may in this case take place discontinuously in one portion, discontinuously in two or more portions, and also continuously, with constant or varying flow rates. Preferably the total amount of monomers A is included in the initial charge to the polymerization vessel before the polymerization reaction is initiated.

In accordance with the invention it is possible, optionally, to include up to 10%, frequently ≦5%, by weight each of the total amounts of monomers B to D in the initial charge to the polymerization vessel before the polymerization reaction is initiated. It is advantageous not to include any of monomers B to D in the initial charge to the polymerization vessel. Any remainders or the total amounts of monomers B to D can be added to the polymerization vessel after the free-radical polymerization reaction has been initiated, and this can be done discontinuously in one portion, discontinuously in two or more portions, and continuously, with constant or varying flow rates. With advantage the monomers B to D are added continuously with constant flow rates. With advantage, the monomers B to D are added in the form of a monomer mixture, and with particular advantage in the form of an aqueous monomer emulsion.

In accordance with the invention, for the purposes of the present process, dispersants are used which maintain not only the monomer droplets but also the resultant polymer particles in dispersed distribution in the aqueous medium and so ensure the stability of the aqueous polymer dispersion produced. Suitable dispersants include not only the protective colloids typically used to implement free-radical aqueous emulsion polymerizations, but also emulsifiers.

Examples of suitable protective colloids include polyvinyl alcohols, polyalkylene glycols, alkali metal salts of polyacrylic acids and polymethacrylic acids, gelatine derivatives or copolymers comprising acrylic acid, methacrylic acid, maleic anhydride, 2-acrylamido-2-methylpropanesulfonic acid and/or 4-styrenesulfonic acid, and the alkali metal salts of such copolymers, and also homopolymers and copolymers comprising N-vinylpyrrolidone, N-vinylcaprolactam, N-vinylcarbazole, 1-vinylimidazole, 2-vinylimidazole, 2-vinylpyridine, 4-vinylpyridine, acrylamide, methacrylamide, amino-bearing acrylates, methacrylates, acrylamides and/or methacrylamides. An exhaustive description of further suitable protective colloids is found in Houben-Weyl, Methoden der organischen Chemie, Volume XIV/1, Makromolekulare Stoffe [Macromolecular Compounds], Georg-Thieme-Verlag, Stuttgart, 1961, pages 411-20.

It will be appreciated that mixtures of protective colloids and/or emulsifiers as well can be used. Dispersants used are frequently exclusively emulsifiers, whose relative molecular weights, in contradistinction to the protective colloids, are usually below 1000. They may be anionic, cationic or nonionic in nature. It will be appreciated that, when using mixtures of surface-active substances, the individual components must be compatible with one another, something which in case of doubt can be ascertained by means of a few preliminary tests. Generally speaking, anionic emulsifiers are compatible with one another and with nonionic emulsifiers. The same is true of cationic emulsifiers, whereas anionic and cationic emulsifiers are usually not compatible with one another. An overview of suitable emulsifiers is found in Houben-Weyl, Methoden der organischen Chemie, Volume XIV/1, Makromolekulare Stoffe [Macromolecular Compounds], Georg-Thieme-Verlag, Stuttgart, 1961, pages 192-208.

In particular, however, emulsifiers are used as dispersants in accordance with the invention.

Customary nonionic emulsifiers are, for example, ethoxylated mono-, di-, and tri-alkylphenols (EO degree: 3 to 50, alkyl radical: C₄ to C₁₂) and also ethoxylated fatty alcohols (EO degree: 3 to 80; alkyl radical: C₈ to C₃₆). Examples thereof are the Lutensol® A grades (C₁₂C₁₄ fatty alcohol ethoxylates, EO degree: 3 to 8), Lutensol® AO grades (C₁₃C₁₅ oxo alcohol ethoxylates, EO degree: 3 to 30), Lutensol® AT grades (C₁₆C₁₈ fatty alcohol ethoxylates, EO degree: 11 to 80), Lutensol® ON grades (C₁₀ oxo alcohol ethoxylates, EO degree 3 to 11), and Lutensol® TO grades (C₁₃ oxo alcohol ethoxylates, EO degree: 3 to 20), all from BASF AG.

Typically anionic emulsifiers are, for example, alkali metal salts and ammonium salts of alkyl sulfates (alkyl radical: C₈ to C₁₂), of sulfuric monoesters with ethoxylated alkanols (EO degree: 4 to 30, alkyl radical: C₁₂ to C₁₈) and ethoxylated alkylphenols (EO degree: 3 to 50, alkyl radical: C₄ to C₁₂), of alkylsulfonic acids (alkyl radical: C₁₂ to C₁₈), and of alkylarylsulfonic acids (alkyl radical: C₉ to C₁₈).

Compounds which have proven suitable as further anionic emulsifiers are, additionally, compounds of the general formula (I)

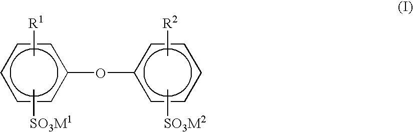

in which R¹ and R² are hydrogen atoms or C₄ to C₂₄ alkyl but are not simultaneously hydrogen atoms, and M¹ and M² can be alkali metal ions and/or ammonium ions. In the general formula (I) R¹ and R² are preferably linear or branched alkyl radicals having 6 to 18 carbon atoms, in particular having 6, 12, and 16 carbon atoms, or hydrogen, but R¹ and R² are not both simultaneously hydrogen atoms. M¹ and M² are preferably sodium, potassium or ammonium, particular preference being given to sodium. Particularly advantageous compounds (I) are those in which M¹ and M² are sodium, R¹ is a branched alkyl radical of 12 carbon atoms and, R² is a hydrogen atom or R¹. Frequently use is made of technical mixtures containing a fraction of 50% to 90% by weight of the monoalkylated product, an example being Dowfax® 2A1 (brand of the Dow Chemical Company). The compounds (I) are common knowledge, from U.S. Pat. No. 4,269,749 for example, and are available commercially.

Suitable cation-active emulsifiers are generally C₆ to C₁₈ alkyl-, C₆ to C₁₈ alkylaryl- or heterocyclyl-containing primary, secondary, tertiary or quaternary ammonium salts, alkanolammonium salts, pyridinium salts, imidazolinium salts, oxazolinium salts, morpholinium salts, thiazolinium salts, and salts of amine oxides, quinolinium salts, isoquinolinium salts, tropylium salts, sulfonium salts and phosphonium salts. Examples that may be mentioned include dodecylammonium acetate or the corresponding sulfate, the sulfates or acetates of the various paraffinic acid 2-(N,N,N-trimethylammonio)ethyl esters, N-cetylpyridinium sulfate, N-laurylpyridinium sulfate, and N-cetyl-N,N,N-trimethylammonium sulfate, N-dodecyl-N,N,N-trimethylammonium sulfate, N-octyl-N,N,N-trimethlyammonium sulfate, N,N-distearyl-N,N-dimethylammonium sulfate, and the gemini surfactant N,N′-(lauryldimethyl)ethylenediamine disulfate, ethoxylated tallowyl-N-methylammonium sulfate and ethoxylated oleylamine (for example Uniperol® AC from BASF AG, about 12 ethylene oxide units). Numerous further examples are found in H. Stache, Tensid-Taschenbuch, Carl-Hanser-Verlag, Munich, Vienna, 1981 and in McCutcheon's, Emulsifiers & Detergents, MC Publishing Company, Glen Rock, 1989. It is advantageous if the anionic counter-groups are, as far as possible, of low nucleophilicity, such as, for example, perchlorate, sulfate, phosphate, nitrate, and carboxylates, such as acetate, trifluoroacetate, trichloroacetate, propionate, oxalate, citrate, and benzoate, and also conjugated anions of organic sulfonic acids, such as methylsulfonate, trifluoromethylsulfonate, and para-toluenesulfonate, and additionally tetrafluoroborate, tetraphenylborate, tetrakis(pentafluorophenyl)borate, tetrakis[bis(3,5-trifluoromethyl)phenyl]borate, hexafluorophosphate, hexafluoroarsenate or hexafluoroantimonate.

The emulsifiers used with preference as dispersants are employed advantageously in a total amount≧0.005% and ≦10%, preferably ≧0.01% and ≦5%, in particular ≧0.1% and ≦3%, by weight, based in each case on the total monomer amount.

The total amount of protective colloids used as dispersants, additionally or in lieu of the emulsifiers, is often ≧0.1% and ≦10% and frequently ≧0.2% and ≦7%, by weight, based in each case on the total monomer amount.

It is preferred, however, to use anionic and/or nonionic emulsifiers, and particularly preferred to use anionic emulsifiers, as dispersants.

The free-radically initiated aqueous emulsion polymerization is started off by means of a free-radical polymerization initiator. Initiators may in principle be both peroxides and azo compounds. It will be appreciated that redox initiator systems as well are suitable. Peroxides used may in principle be inorganic peroxides, such as hydrogen peroxide or peroxodisulfates, such as the mono- or di-alkali metal or -ammonium salts of peroxodisulfuric acid, such as their mono- and di-sodium, -potassium or -ammonium salts, for example, or organic peroxides, such as alkyl hydroperoxides, examples being tert-butyl, p-menthyl, and cumyl hydroperoxide, and also dialkyl or diaryl peroxides, such as di-tert-butyl peroxide or dicumyl peroxide. As an azo compound use is made substantially of 2,2″-azobis(isobutyronitrile), 2,2″-azobis(2,4-dimethylvaleronitrile), and 2,2″-azobis(amidinopropyl) dihydrochloride (AIBA, corresponding to V-50 from Wako Chemicals). Suitable oxidizing agents for redox initiator systems include substantially the aforementioned peroxides. As corresponding reducing agents it is possible to use sulfur compounds with a low oxidation state, such as alkali metal sulfites, examples being potassium and/or sodium sulfite, alkali metal hydrogensulfites, examples being potassium and/or sodium hydrogensulfite, alkali metal metabisulfites, examples being potassium and/or sodium metabisulfite, formaldehyde-sulfoxylates, examples being potassium and/or sodium formaldehyde-sulfoxylate, alkali metal salts, especially potassium salts and/or sodium salts, of aliphatic sulfinic acids, and alkali metal hydrogensulfides, such as potassium and/or sodium hydrogensulfide, salts of polyvalent metals, such as iron(II) sulfate, iron(II) ammonium sulfate, iron(II) phosphate, endiols, such as dihydroxymaleic acid, benzoin and/or ascorbic acid, and reducing saccharides, such as sorbose, glucose, fructose and/or dihydroxyacetone. In general the amount of free-radical initiator used, based on the total monomer amount, is 0.01% to 5%, preferably 0.1% to 3%, and more preferably 0.2% to 1.5% by weight.

In accordance with the invention the entirety of the free-radical initiator can be included in the initial charge in the aqueous reaction medium before initiation of the polymerization reaction. An alternative possibility is to include, if appropriate, only a portion of the free-radical initiator in the initial charge in the aqueous reaction medium before initiation of the polymerization reaction and then under polymerization conditions to add the entirety or the remainder, if appropriate, at the rate at which it is consumed in the course of the free-radical emulsion polymerization of the invention, such addition taking place continuously or discontinuously.

By initiation of the polymerization reaction is meant the start of the polymerization reaction of the monomers present in the polymerization vessel, following the formation of free radicals by the free-radical initiator. In this context it is possible for the polymerization reaction to be initiated by addition of free-radical initiator to the aqueous polymerization mixture in the polymerization vessel under polymerization conditions. An alternative option is to add some or all of the free-radical initiator to the aqueous polymerization mixture in the polymerization vessel, comprising the initial monomer charge, under conditions which are not suitable for triggering a polymerization reaction, such as at low temperature, for example, and subsequently to set polymerization conditions in the aqueous polymerization mixture. By polymerization conditions in this context are meant, generally speaking, those temperatures and pressures under which the free-radically initiated aqueous emulsion polymerization proceeds at a sufficient polymerization rate. They are dependent in particular on the free-radical initiator used. Advantageously the nature and amount of the free-radical initiator, polymerization temperature and polymerization pressure are all selected such that the free-radical initiator has a half-life ≦3 hours, with particular advantage ≦1 hour, and with very particular advantage ≦30 minutes, and at the same time there are always sufficient initiating radicals available to initiate or maintain the polymerization reaction.

Suitable reaction temperatures for the free-radical aqueous emulsion polymerization of the invention embrace the entire range from 0 to 170° C. In general the temperatures used are 50 to 120° C., frequently 60 to 110° C., and often 70 to 100° C. The free-radical aqueous emulsion polymerization of the invention can be carried out at a pressure less than, equal to or greater than 1 bar (absolute), and the polymerization temperature may consequently exceed 100° C. and amount to up to 170° C. Highly volatile monomers, such as 2-methylbut-1-ene, 3-methylbut-1-ene, 2-methylbut-2-ene, butadiene or vinyl chloride, are preferably polymerized under superatmospheric pressure. This pressure may adopt values of 1.2, 1.5, 2, 5, 10 or 15 bar or even higher. Where emulsion polymerizations are carried out under subatmospheric pressure, pressures of 950 mbar, frequently of 900 mbar, and often 850 mbar (absolute) are set. The free-radical aqueous emulsion polymerization of the invention is conducted advantageously at 1 atm (1.013 bar absolute) under an inert gas atmosphere, such as under nitrogen or argon, for example.

The aqueous reaction medium may in principle also comprise water-soluble organic solvents, such as methanol, ethanol, isopropanol, butanols, pentanols, but also acetone, etc. With preference, however, the process of the invention is carried out in the absence of such solvents.

Besides the aforementioned components it is also possible optionally in the process of the invention to use free-radical chain transfer compounds in order to reduce or to control the molecular weight of the polymers obtainable by means of the polymerization. Suitable compounds in this context include, substantially aliphatic and/or araliphatic halogen compounds, such as n-butyl chloride, n-butyl bromide, n-butyl iodide, methylene chloride, ethylene dichloride, chloroform, bromoform, bromotrichloromethane, dibromodichloromethane, carbon tetrachloride, carbon tetrabromide, benzyl chloride, benzyl bromide, organic thio compounds, such as primary, secondary or tertiary aliphatic thiols, such as ethanethiol, n-propanethiol, 2-propanethiol, n-butanethiol, 2-butanethiol, 2-methyl-2-propanethiol, n-pentanethiol, 2-pentanethiol, 3-pentanethiol, 2-methyl-2-butanethiol, 3-methyl-2-butanethiol, n-hexanethiol, 2-hexanethiol, 3-hexanethiol, 2-methyl-2-pentanethiol, 3-methyl-2-pentanethiol, 4-methyl-2-pentanethiol, 2-methyl-3-pentanethiol, 3-methyl-3-pentanethiol, 2-ethylbutanethiol, 2-ethyl-2-butanethiol, n-heptanethiol and its isomers, n-octanethiol and its isomers, n-nonanethiol and its isomers, n-decanethiol and its isomers, n-undecanethiol and its isomers, n-dodecanethiol and its isomers, n-tridecanethiol and its isomers, substituted thiols, such as 2-hydroxyethanethiol, aromatic thiols, such as benzenethiol, ortho-, meta-, or para-methylbenzenethiol, and also all other sulfur compounds described in the Polymer Handbook, 3rd edition, 1989, J. Brandrup and E. H. Immergut, John Wiley & Sons, Section II, pages 133-41, and also aliphatic and/or aromatic aldehydes, such as acetaldehyde, propionaldehyde and/or benzaldehyde, unsaturated fatty acids, such as oleic acid, dienes containing nonconjugated double bonds, such as divinylmethane or vinylcyclohexane, or hydrocarbon having readily obstructable hydrogen atoms, such as toluene. It is, however, also possible to use mixtures of mutually compatible aforementioned free-radical chain transfer compounds.

The total amount of free-radical chain transfer compounds used optionally in the process of the invention, based on the total monomer amount, is generally ≦5%, often ≦3%, and frequently ≦1% by weight.

It is advantageous if a portion or the entirety of the optionally employed free-radical chain transfer compound is supplied to the reaction medium before the free-radical polymerization is initiated. Furthermore, a portion or the entirely of the free-radical chain transfer compound may with advantage also be supplied to the aqueous reaction medium together with the monomers B to D during the polymerization.

The polymers obtainable by the process of the invention may in principle have glass transition temperatures in the range of −70 to +150° C., often −30 to +100° C., and frequently −20 to +50° C. Where the aqueous polymer dispersion is to be used to prepare adhesives, especially pressure-sensitive adhesives, monomers A to D are chosen such that the resultant polymer has a glass transition temperature, T_{g}, ≦+20° C. Frequently monomers A to D are chosen such that polymers having a T_{g}≦+10° C., ≦0° C., ≦−10° C., ≦−20° C., ≦−30° C., ≦−40° C. or ≦−50° C. are formed. It is, however, also possible to prepare polymers whose glass transition temperatures are between −70 and +10° C., between −60 and −10° C. or between −50 and −20° C. By glass transition temperature here is meant the midpoint temperature according to ASTM D 3418-82, determined by differential thermoanalysis (DSC) [cf. also Ullmann's Encyclopedia of Industrial Chemistry, page 169, Verlag Chemie, Weinheim, 1992, and Zosel in Farbe and Lack, 82, pages 125-34, 1976].

According to Fox (T. G. Fox, Bull. Am. Phys. Soc. 1956 [Ser. II] 1, page 123 and in accordance with Ullmann's Encyclopadie der technischen Chemie, Vol. 19, page 18, 4th edition, Verlag Chemie, Weinheim, 1980) the glass transition temperature of copolymers with no more than low degrees of crosslinking is given in good approximation by

1/T_{g}=x¹/T_{g}¹+x²/T_{g}²+ . . . xⁿ/T_{g}ⁿ,

where x¹, x², . . . xⁿ are the mass fractions of the monomers 1, 2, . . . n and T_{g}¹, T_{g}², . . . T_{g}ⁿ are the glass transition temperatures of the polymers synthesized in each case only from one of the monomers 1, 2, . . . n, in degrees Kelvin. The glass transition temperatures of these homopolymers for the majority of ethylenically unsaturated monomers are known (or can be easily determined experimentally in conventional manner) and are listed, for example, in J. Brandrup, E. H. Immergut, Polymer Handbook 1st ed., J. Wiley, New York, 1966, 2nd ed., J. Wiley, New York, 1975, and 3rd ed., J. Wiley, New York, 1989, and also in Ullmann's Encyclopedia of Industrial Chemistry, page 169, Verlag Chemie, Weinheim, 1992.

Optionally the free-radical initiated aqueous emulsion polymerization can also be effected in the presence of a polymer seed: for example, in the presence of 0.01% to 3%, frequently of 0.02% to 2%, and often of 0.04% to 1.5% by weight of a polymer seed, based in each case on the total monomer amount.

A polymer seed is employed in particular when the particle size of the polymer particles to be prepared by means of free-radically aqueous emulsion polymerization is to be set to a particular target figure (in this regard see, for example, U.S. Pat. No. 2,520,959 and U.S. Pat. No. 3,397,165).

Use is made in particular of a polymer seed whose polymer seed particles have a narrow size distribution and have weight-average diameters D_{w}≦100 nm, frequently ≧5 nm to ≦50 nm, and often ≧15 nm to ≦35 nm. Determination of the weight-average particle diameter is known to the skilled worker and is accomplished for example by the method of the analytical ultracentrifuge. By weight-average particle diameter in this text is meant the weight-average D_{w50} value as determined by the method of the analytical ultracentrifuge (in this regard cf. S. E. Harding et al., Analytical Ultracentrifugation in Biochemistry and Polymer Science, Royal Society of Chemistry, Cambridge, Great Britain 1992, Chapter 10, Analysis of Polymer Dispersions with an Eight-Cell AUC Multiplexer: High Resolution Particle Size Distribution and Density Gradient Techniques, W. Machtle, pages 147-75).

A narrow particle size distribution exists for the purposes of this text when the ratio of the weight-average particle diameter D_{w50} to the number-average particle diameter Dₙ₅₀ [D_{w50}/Dₙ₅₀], as determined by the method of the analytical ultracentrifuge, is ≦2.0, preferably ≦1.5, and more preferably ≦1.2 or ≦1.1.

The polymer seed is typically used in the form of an aqueous polymer dispersion. The abovementioned figures refer to the polymer solids fraction of the aqueous polymer seed dispersion; they are therefore given as parts by weight of polymer seed solids, based on the total monomer amount.

If a polymer seed is used then it is advantageous to use an exogenous polymer seed. Unlike an in situ polymer seed, which is prepared in the reaction vessel before the emulsion polymerization is commenced, and which has the same monomeric composition as the polymer prepared by the subsequent free-radically initiated aqueous emulsion polymerization, an exogenous polymer seed is a polymer seed which has been prepared in a separate reaction step and whose monomeric composition is different than that of the polymer prepared by the free-radically initiated aqueous emulsion polymerization, although this means nothing more than that different monomers, or monomer mixtures with a different composition, are used for preparing the exogenous polymer seed and for preparing the aqueous polymer dispersion. The preparation of an exogenous polymer seed is familiar to the skilled worker and is typically accomplished by the introduction as initial charge to a reaction vessel of a relatively small amount of monomers and of a relatively large amount of emulsifiers, and by the addition at reaction temperature of a sufficient amount of polymerization initiator.

It is preferred in accordance with the invention to use an exogenous polymer seed having a glass transition temperature ≧50° C., frequently ≧60° C. or ≧70° C., and often ≧80° C. or ≧90° C. A polystyrene or polymethyl methacrylate polymer seed is particularly preferred.

The total amount of exogenous polymer seed can be included in the initial charge to the polymerization vessel together with monomers A. An alternative option is to include only a portion of the exogenous polymer seed in the initial charge to the polymerization vessel with the monomers A, and to add the remaining amount during the polymerization together with monomers B to D. If necessary, however, the total amount of polymer seed can be added in the course of the polymerization. It is preferred to include the total amount of exogenous polymer seed in the initial charge to the polymerization vessel before initiation of the polymerization reaction commenced.

The aqueous polymer dispersions accessible in accordance with the invention typically have a polymer solids content of ≧10% and ≦70% by weight, frequently ≧20% and ≦65%, and often ≧25% and ≦60% by weight, based in each case on the aqueous polymer dispersion. The number-average particle diameter determined by quasielastic light scattering (ISO standard 13 321), i.e., the cumulant z-average, is in general between 10 and 2000 nm, frequently between 20 and 1000 nm, and often between 100 and 700 nm or 100 to 400 nm.

Frequently, in the aqueous polymer dispersions obtained, the residual amounts of unreacted monomers and of other low-boiling compounds are lowered by means of chemical and/or physical methods that are likewise known to the skilled worker [see, for example, EP-A 771328, DE-A 19624299, DE-A 19621027, DE-A 19741184, DE-A 19741187, DE-A 19805122, DE-A 19828183, DE-A 19839199, DE-A 19840586, and 19847115].

The aqueous polymer dispersions obtainable by the process of the invention feature a significantly higher monomer conversion for the same polymerization time, or a higher polymer solids content after the polymerization reaction has finished.

The aqueous polymer dispersions obtainable by the process of the invention can be used in particular for producing adhesives, sealants, polymeric renders, paper coating slips, fiber webs, paints, and coating materials for organic substrates, such as leather or textiles, for example, and also for modifying mineral binders.

In their adhesives utility, particularly as pressure-sensitive adhesives, the aqueous polymer dispersions obtainable in accordance with the process of the invention are admixed preferably with a tackifier, i.e., a tackifying resin. Tackifiers are known for example from Adhesives Age, July 1987, pages 19-23 or Polym. Mater. Sci. Eng. 61 (1989), pages 588-92.

Tackifiers are, for example, natural resins, such as rosins and their derivatives resulting from disproportionation or isomerization, polymerization, dimerization or hydrogenation. They may be present in their salt form (with monovalent or polyvalent counterions [cations], for example) or, preferably, in their esterified form. Alcohols used for esterification may be monohydric or polyhydric. Examples are methanol, ethanediol, diethylene glycol, triethylene glycol, 1,2,3-propanetriol (glycerol) or pentaerythritol.

Also used, furthermore, are hydrocarbon resins, examples being coumarone-indene resins, polyterpene resins, hydrocarbon resins based on unsaturated CH compounds, such as butadiene, pentene, methylbutene, isoprene, piperylene, divinylmethane, pentadiene, cyclopentene, cyclopentadiene, cyclohexadiene, styrene, α-methylstyrene or vinyltoluenes.

Further compounds increasingly being used as tackifiers are polyacrylates of low molecular weight. These polyacrylates preferably have a weight-average molecular weight of below 30 000 g/mol. The polyacrylates are preferably composed of at least 60%, in particular at least 80%, by weight of C₁-C₈-alkyl acrylates or methacrylates.

Preferred tackifiers are natural or chemically modified rosins. Rosins are composed predominantly of abietic acid or its derivatives.

The tackifiers can be added in a simple way to the aqueous polymer dispersions obtainable in accordance with the invention. The tackifiers are preferably themselves in the form of an aqueous dispersion.

The amount of tackifiers is preferably 5% to 100% by weight, particularly 10% to 50% by weight, based in each case on the total amount of the polymer (solids/solids).

Besides tackifiers it is also possible, as will be appreciated, for other typical additives as well to be used, examples being thickeners, defoamers, plasticizers, pigments, wetting agents or fillers, when formulating pressure-sensitive adhesives.

The aqueous polymer dispersions can be applied by typical methods, such as by rolling, knifecoating, spreading, etc., to substrates, such as paper or polymer belts and polymer films, for example, composed preferably of polyethylene, polypropylene, which may have been biaxially or monoaxially oriented, polyethylene terephthalate, polyvinyl chloride, polystyrene, polyamide, or metal surfaces. The water can be removed easily by drying at 50 to 150° C. For subsequent use, the side of the substrates that is coated with pressure-sensitive adhesive, of the labels or tapes for example, can be lined with a release paper, such as with a siliconized paper, for example.

The aqueous polymer dispersions obtainable by the process of the invention are suitable with advantage as a component in adhesives, especially pressure-sensitive adhesives. These adhesives of the invention advantageously exhibit improved adhesion to surfaces of plastics, especially polyethylene surfaces.

The following, nonlimiting examples are intended to elucidate the invention.

### EXAMPLE

A 4 l four-neck flask equipped with an anchor stirrer, reflux condenser, and two metering devices was charged at 20 to 25° C. (room temperature) and under nitrogen with 970 g of deionized water, 42.4 g of an aqueous polystyrene seed (solids content 33% by weight, number-average particle diameter 32 nm), 212 g of oct-1-ene, 12.3 g of a 40% strength by weight aqueous solution of Emulgator K30® emulsifier from Lanxess, Leverkusen (mixture of primary and secondary sodium alkylsulfonates having an average chain length of 15 carbon atoms), and 1.5 g of sodium persulfate and this initial charge was heated to 90° C. with stirring. After the temperature had been reached, the monomer feed, consisting of 600 g of deionized water, 12.3 g of a 40% strength by weight aqueous solution of Emulgator K30®, 11.2 g of a 25% strength by weight aqueous solution of sodium hydroxide, 1184 g of n-butyl acrylate, and 5.6 g of allyl methacrylate, and the initiator feed, consisting of 110 g of deionized water and 8.3 g of sodium persulfate, were commenced at the same time, the monomer feed being metered in continuously over 3 hours and the initiator feed continuously over 3.5 hours. Subsequently the aqueous polymer dispersion obtained was left to afterreact at 90° C. for 2 hours, before being cooled to room temperature. The aqueous polymer dispersion obtained had a solids content of 45% by weight, based on the total weight of the aqueous polymer dispersion. The glass transition temperature of the polymer was −47° C.

The solids content was determined by drying a defined amount of the aqueous polymer dispersion (approximately 5 g) to constant weight in a drying cabinet at 140° C. Two separate measurements were carried out. The value reported in the example represents the average of the two results.

The glass transition temperature was determined in accordance with DIN 53765 using a DSC 820 instrument, series TA 8000, from Mettler-Toledo.

### COMPARATIVE EXAMPLE

The comparative example was carried out in the same way as for the inventive example but with the difference that the total amount of 212 g of oct-1-ene was metered in together with the monomer feed. The aqueous polymer dispersion obtained had a solids content of 40% by weight, based on the total weight of the aqueous polymer dispersion. The glass transition temperature of the polymer was −44° C.

1. A process for preparing an aqueous polymer dispersion by free-radically initiated aqueous emulsion polymerization of ethylenically unsaturated monomers in the presence of at least one dispersant and at least one free-radical initiator, using
1 to 50% by weight of an alkene of 5 to 12 carbon atoms [monomer A] and
50 to 99% by weight of an ester based on an α,β-monoethylenically unsaturated monocarboxylic or dicarboxylic acid of 3 to 6 carbon atoms and an alkanol of 1 to 12 carbon atoms [monomer B], and also, if appropriate,
0 to 10% by weight of an α,β-monoethylenically unsaturated monocarboxylic or dicarboxylic acid of 3 to 6 carbon atoms and/or amide thereof [monomer C] and
0 to 30% by weight of an α,β-etthylenically unsaturated compound [monomer D] different than monomers A to C
for the emulsion polymerization, monomers A to D adding to 100% by weight, wherein at least 50% by weight of the total amount of monomers A and optionally up to 10% by weight each of the total amounts of monomers B to D are included in the initial charge to the polymerization vessel before the polymerization reaction is initiated, and any remainder of monomers A, and the total amounts or, if appropriate, the remainders of monomers B to D are supplied to the polymerization vessel under polymerization conditions.

2. The process according to claim 1, wherein
1 to 49.99% by weight of monomer A,
50 to 98.99% by weight of monomer B, and
0.01 to 10% by weight of monomer C are used.

3. The process according to claim 1, wherein a 1-alkene is used as monomer A.

4. The process according to claim 1, wherein an ester based on an α,β-monoethylenically unsaturated monocarboxylic or dicarboxylic acid of 3 or 4 carbon atoms and an alkanol of 1 to 8 carbon atoms is used as monomer B.

5. The process according to claim 1, wherein an alkene of 6 to 8 carbon atoms is used as monomer A.

6. The process according to claim 1, wherein at least 80% by weight of the total amount of monomers A are included in the initial charge to the polymerization vessel before the polymerization reaction is initiated.

7. The process according to claim 1, wherein the total amount of monomers A is included in the initial charge to the polymerization vessel before the polymerization reaction is initiated.

8. The process according to claim 1, wherein the total amounts or, if appropriate, the remainders of monomers B to D are metered continuously at constant flow rates to the polymerization vessel under polymerization conditions.

9. The process according to claim 1, wherein the total amounts or, if appropriate, the remainders of monomers B to D are metered into the polymerization vessel as a monomer mixture under polymerization conditions.

10. The process according to claim 9, wherein the total amounts or, if appropriate, the remainders of monomers B to D are metered into the polymerization vessel in the form of an aqueous monomer emulsion.
